(19) United States
(12) Patent Application Publication
(10) Pub. No.: US 2002/0171676 A1
(43) Pub. Date: Nov. 21, 2002

(54) Multiple user application entry process

(76) Inventors: Todres Yampel, Brooklyn, NY (US); Gad Janay, Boca Raton, FL (US)

Correspondence Address: KAPLAN & GILMAN , L.L.P., 900NROUTE 9 NORTH, WOODBRIDGE, NJ, 07095, US

(21) Appl. No.: 09/862,193

(22) Filed: May 21, 2001

(51) Int. Cl. G06F 13/00

(52) U.S. Cl. 345/733; 345/742

(57) ABSTRACT

A computer program is provided in which a second, or subsequent, user of an application is permitted to bypass the steps involved in logging onto the application and navigating through a series of preliminary screens by being granted the seat, or screen level, of a first user who has exited the program. The program archives the application screen level and assigns a macro that is adapted to accessing the first user's screen level by the second or subsequent user.

### FIELD OF THE INVENTION

The present invention relates to the field of computer software and more particularly to the field of computer applications in multiple user environments to permit a subsequent user to enter a computer application at a screen level where a prior user exited the application.

### BACKGROUND OF THE INVENTION

There are many situations in which access to an application, or computer-based program, involves multiple logon steps and navigation of multiple preliminary screens to connect, or obtain a “seat.” When the application is intended for use at a number of terminals, as in a large office or company branch, each new user has to perform the same series of logon steps. This process is duplicative, thus wasteful of time and resources. If the number of users is large, the cumulative loss can be large.

This situation occurs typically in such environments as a bank, where the application may contain customer account records, or a manufacturing operation, where the application may be used to store and manipulate information regarding work in process. In any case, it is not practical to keep the application open on each terminal, because of the amount of memory required on the system. The result is that each user logs off the application when the session is complete and each new user logs on, following the same series of steps beginning at the first screen. A further area in which redundant steps of log on and clicking through multiple layers of archival organization is in governmental records that are available for public access, e.g. tax records, real estate deeds, etc. Even though the objective is for the public to readily obtain the information, the currently known programs require each user to navigate the same series of entry steps.

The waste of time and resources due to duplication could be reduced if a system were available in which a subsequent user is able to open an application and immediately obtain the seat of a prior user who has terminated a session.

Therefore, it is an object of the present invention to provide a process by which subsequent users can open an application without repeating the logon and opening steps that were done by a prior user of the application.

This and other objects will become more apparent from the description of the invention to follow.

### SUMMARY OF THE INVENTION

To allow a subsequent user of an application to activate the application without repeating the initial logon and screen navigating steps performed by an earlier user, a number of macros, or established process steps, are provided by a system control program. The macros are identified by the screen structure for a particular application. When a user exits the application, the system control program determines the program exit point and archives the last active screen level to a reservation pool. When the next user desires to open the application, the system control program provides the new user access at the prior user's seat, or exit screen level, saving time for the user and generally improving efficiency. The greater the number of users and access occurrences, the greater the savings.

### BRIEF DESCRIPTION OF THE DRAWINGS

FIG. 1 is a flowchart depicting the operational steps involved in accessing and using a computer system application by more than one user, according to the prior art.

FIG. 2 is a flowchart depicting the operational steps involved in accessing and using a computer program by more than one user, according to the present invention.

### DETAILED DESCRIPTION OF THE INVENTION

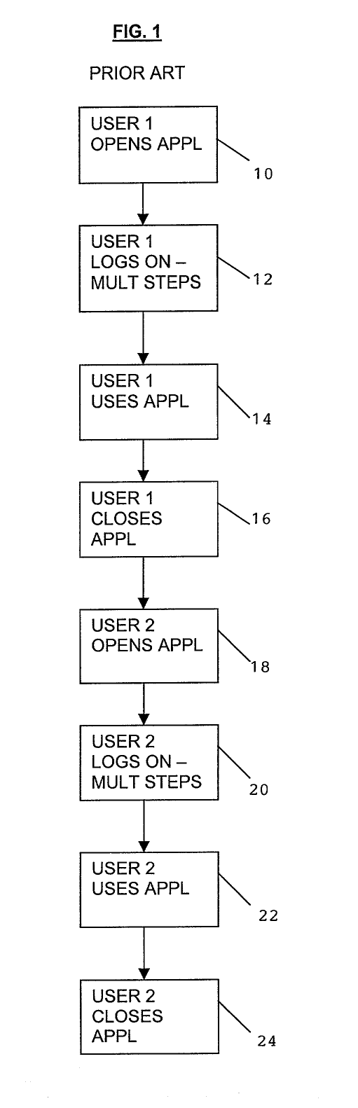

Referring now to FIG. 1, a flowchart of a multiple user application entry process according to the prior art is presented. The flowchart is solely directed to an outline of the steps involved in opening, logging on, using and closing a computer application by two sequential users. Further subsequent users would perform the same steps as the second user does. The operation of logging on typically incorporates multiple steps, as noted in operation box 12, although the actual number of steps involved depends on the particular program.

In operation box 10 of FIG. 1, a first user opens the application on a computer terminal. Subsequent to opening the application, the first user logs onto the application at box 12. The logon process might involve a differing number of screens and steps. For example, if the application were to be used in a bank location, the logon steps may include identification of the branch or department, identification of access number, identification of type of query, etc. In addition, this multiple step process involves navigating through a number of screens to arrive at a screen level at which the necessary work is to be done. Thus, the steps represented at box 12 may actually be many steps.

At box 14, the first user actually uses the application, for example by searching for information or entering data. Upon completion of use, the first user closes the application at box 16. Typically, when a user of a program logs off, the user is disconnected and the application resets the resources that had been assigned to that user so that any subsequent user is required to activate the program and logon from the initial screen.

When a second user enters the system, the second user follows the same sequence of steps as the first user, which is portrayed in the FIG. 1 flowchart as steps 18-24, including a re-allocation of resources. It is therefore noted that the second user is required to negotiate the same number of steps as the first user. While the second user will not likely use the application to perform the same queries to obtain information, or enter the same information as the first user, the logon operations are typically identical in the same facility, and the steps of negotiating multiple levels are the same, essentially duplicating effort. The second user, or other subsequent user, opens the application at operation box 18 and proceeds to logon by multiple steps at box 20. After logging on, and navigating up through multiple layers, the second user of the application performs the necessary processes in the application at box 22, and then logs off the application at the step in operation box 24. As described, the second user is required to perform the same series of steps to access and activate the application as the first user, essentially duplicating effort.

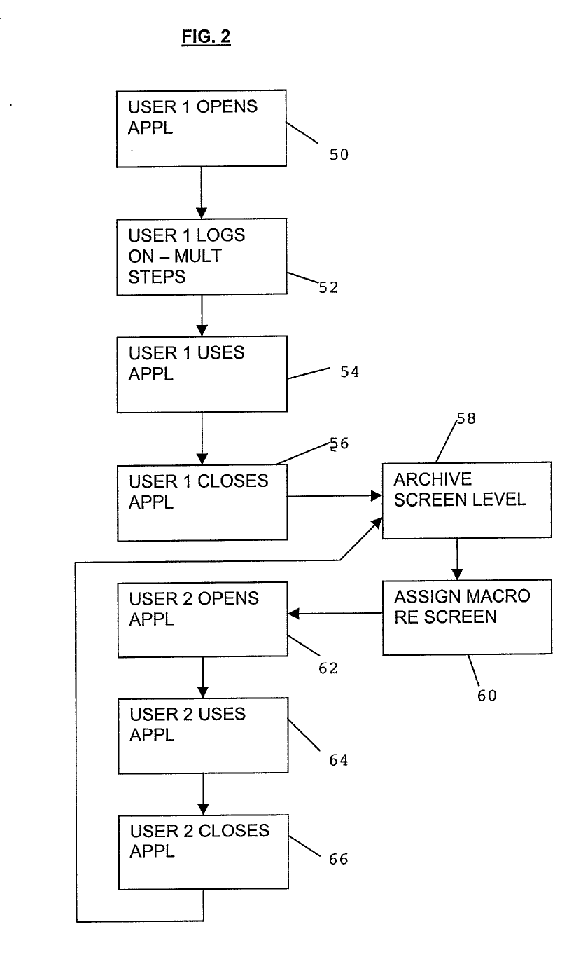

According to the protocol of the present invention, illustrated schematically in FIG. 2, the first user opens the application at the operation of box 50. The first user then logs onto the application and performs the necessary multiple steps of navigation to the desired operating level at operation box 52. The first user then uses the application at box 54 and closes the application at the step seen at operation box 56. At the point that the first user exits the application, the application software according to the invention automatically archives the connection by bringing the host application to a pre-defined entry point that bypasses the steps of reconnect, logon, and navigation to the level of use.

The application performs the functions of archiving the screen from which the first user exited in background in operation box 58, without operator intervention. The invention recognizes that performance of operations within a computer program with no operator effort consumes substantially little processing time and improving efficiency. Upon archiving the screen at box 58, the application assigns a customized subroutine, or macro, to the exited screen at box 60, by which a second or subsequent user can expeditiously enter the application without duplicating the preliminary steps of the first user.

When a second, or subsequent, user opens the application at the step illustrated in box 62, the application entry protocol of the invention draws from the reservation pool through the assigned macro and presents the user with the screen from which the first, or other prior, user exited the application. The second user is able at step 64 to use the application for queries or data entry without the need to go through the logon and screen-navigation process. After the second user uses the application, the second user closes the application at operation step 66, and the program cycles back to archive the screen level of exit for the second user in the reservation pool at step 58. Additional subsequent users will be able to follow the same sequence of steps as was described in relation to the second user in steps 62-66, saving time and improving efficiency in use of the subject application.

While the present invention is described with respect to specific embodiments thereof, it is recognized that various modifications and variations thereof may be made without departing from the scope and spirit of the invention, which is more clearly understood by reference to the claims appended hereto.

What is claimed is:

1. A process for enabling a subsequent user to enter an application at a screen level from which a first user exited the application, comprising the steps of:
(a) archiving the screen level from which the first user exited the application;
(b) receiving a request from a subsequent user to enter the application; and
(c) allowing the subsequent user to enter the application at a screen level at which the first user exited the application.

2. The process as described in claim 1, further comprising assigning a macro associated with the screen that is active when the first user exits the application.

3. The process as described in claim 1, further comprising providing a connection pool for archiving the screen level of the first user when the first user exits the application.

4. A process for enabling a subsequent user to enter an application at a level from which a first user exited the application, comprising the steps of:
(a) allowing a first user of the application to open the application;
(b) allowing the first user to log on to the application;
(c) allowing the first user to navigate through multiple screen levels to attain a screen level for use;
(d) allowing the first user to use the application;
(e) allowing the first user to exit the application;
(f) archiving the screen level from which the first user exits the application;
(g) receiving a request from a subsequent user to enter the application; and
(h) allowing the subsequent user to enter the application at the screen level from which the first user exited.

5. The process as described in claim 4, further comprising assigning a macro associated with the screen that is active when the first user exits the application.
